(19) United States
(12) Patent Application Publication
(10) Pub. No.: US 2026/0304236 A1
(43) Pub. Date: Oct. 1, 2026

(54) PRIVACY GROUP AND AID ASSIGNMENT FOR SEAMLESS ROAMING IN ENHANCED PRIVACY NETWORKS

(71) Applicant: Cisco Technology, Inc., San Jose, CA (US)

(72) Inventors: Binita GUPTA, San Diego, CA (US); Brian D. HART, Sunnyvale, CA (US); Malcolm M. SMITH, Richardson, TX (US); Jerome HENRY, Pittsboro, NC (US)

(21) Appl. No.: 19/636,520

(22) Filed: Apr. 1, 2026

Related U.S. Application Data
(60) Provisional application No. 63/781,739, filed on Apr. 1, 2025.

(51) Int. Cl. H04W 36/00; H04W 12/02; H04W 36/18

(52) U.S. Cl. CPC H04W 36/0016; H04W 12/02; H04W 36/18

(57) ABSTRACT

The present disclosure provides techniques for determining a privacy group placement and sequence of association identifiers (AIDs) for a wireless station (STA), including receiving a roaming request for roaming to a first access point (AP) from a wireless STA, where the wireless STA is associated with a second AP, and where the roaming request includes at least one requested privacy parameter. The techniques further include determining, based on the at least one requested privacy parameter, a privacy group placement for the wireless STA, and determining a sequence of AIDs, where the sequence of AIDs represents an ordering and set of AIDs to be used by the first AP to communicate with the wireless STA for a number of privacy group epochs associated with the privacy group placement. The techniques include transmitting a first frame comprising the sequence of AIDs and the privacy group placement to the wireless STA.

### CROSS-REFERENCE TO RELATED APPLICATIONS

This application claims benefit of co-pending United States provisional patent application Serial No. 63/781,739 filed Apr. 1, 2025. The aforementioned related patent applications are herein incorporated by reference in their entirety.

### TECHNICAL FIELD

Embodiments presented in this disclosure generally relate to wireless networks. More specifically, embodiments disclosed herein relate to signaling and negotiating privacy information in enhanced-privacy wireless networks.

### BACKGROUND

Modern wireless networks may employ a number of security features aimed at enhancing the security of the network and its clients. Basic Service Set (BSS) privacy enhancements (BPE) and Client Privacy Enhancement (CPE) techniques, as proposed in the 802.11bi “Enhanced Privacy Protection” (EPP) amendments, enable various BSSs, and clients therein, to preserve privacy and avoid outside tracking of the network, such as through attempting to anonymize identifiers and other parameters of various devices in the network, such as access points (APs) or wireless stations (STAs), by changing identifiers at various time periods.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example environment for wireless network management, according to some embodiments of the present disclosure.

FIG. 2 depicts an example environment for negotiating and assigning privacy parameter values in a wireless network, according to some embodiments of the present disclosure.

FIG. 3 depicts an example format for signaling Enhanced Privacy Protection (EPP) parameters, according to some embodiments of the present disclosure.

FIG. 4A depicts an example format for signaling a sequence of association identifiers (AIDs), according to some embodiments of the present disclosure. FIG. 4B depicts an example field for signaling each AID of a sequence of AIDs, according to some embodiments of the present disclosure.

FIG. 5A depicts an example frame for signaling privacy information in a roaming request, according to some embodiments of the present disclosure. FIG. 5B depicts an example frame for signaling privacy information in a roaming response, according to some embodiments of the present disclosure.

FIG. 6 is a flow diagram depicting an example method for assigning privacy parameter values to a wireless station in a wireless network, according to some embodiments of the present disclosure.

FIG. 7 is a flow diagram depicting an example method for determining and transmitting privacy parameter values, according to some embodiments of the present disclosure.

FIG. 8 depicts an example computing device, such as a network device, configured to perform various embodiments of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### OVERVIEW

One embodiment presented in this disclosure provides a method. The method includes: receiving a roaming request for a first access point (AP) from a wireless station (STA), wherein the wireless STA is associated with a second AP, and wherein the roaming request includes at least one requested privacy parameter; determining, by the first AP and based on the at least one requested privacy parameter, a privacy group placement for the wireless STA; determining, by the first AP, a sequence of association identifiers (AIDs), wherein the sequence of AIDs represents an ordering of AIDs to be used by the first AP to communicate with the wireless STA, and wherein a new AID from the sequence of AIDs is used by the first AP at a boundary associated with the privacy group placement; and transmitting a first frame comprising the sequence of AIDs and the privacy group placement to the wireless STA.

Other embodiments provide an access point comprising one or more memories and one or more processors communicatively coupled to the one or more memories, wherein the one or more processors are configured to, individually or collectively, perform the aforementioned method, as well as those described herein; and a non-transitory computer readable storage medium comprising instructions that when executed configure one or more processors of an access point to perform the aforementioned methods as well as those described herein.

### EXAMPLE EMBODIMENTS

In some embodiments of the present disclosure, techniques are provided to identify a privacy group placement and sequence of AIDs for wireless STAs to utilize within a BPE-enabled and/or CPE-enabled network (generally, an Enhanced Privacy Protection (EPP) or privacy enhanced network).

In many wireless deployments, a wireless STA (e.g., a non-AP multi-link device (MLD)) may associate with a Seamless Mobility Domain (SMD). An SMD may include multiple APs (e.g., AP MLDs), allowing wireless STAs associated with the SMD to roam between APs within the SMD seamlessly without requiring reassociation.

When a STA wants to roam to a different (e.g., target) AP in the SMD, the STA may initiate seamless roaming, also referred to as SMD roaming or SMD Basic Service Set (BSS) transition (ST). The SMD roaming procedure includes a roaming preparation phase and a roaming execution phase. In the roaming preparation phase, the STA (or the non-AP Multi-Link Device) sends a roaming preparation request (e.g., a ST preparation request) to the current AP of the STA to prepare a target AP for SMD roaming. In response to receiving a roaming preparation request from a STA, an AP may prepare the target AP for the STA to perform roaming transition in a subsequent roaming execution phase, where the STA roams to the target AP. As part of either phase of SMD roaming, the wireless STA is assigned an AID by the target AP to track the STA’s new association with the target AP. For example, the AID may be assigned as part of the roaming preparation phase by the target AP.

However, in modern privacy enhanced networks, an AP may periodically change (e.g., at a random or set frequency) AIDs assigned to STAs in an attempt to anonymize each STA’s identity and prevent identification and tracking of the STAs (e.g., clients) by outside actors. While this may result in increased security for the network, seamless roaming requests and responses can be enhanced to support the negotiation of privacy parameters between a STA and an AP, and the determination of a set of AIDs that will be used at different times, such that the SMD roaming procedure is enabled to support client privacy and avoid outside tracking of the clients in the BSS/network.

Embodiments of the present disclosure provide methods, systems, and apparatuses for providing future AIDs and associated information to STAs. More specifically, some embodiments are directed towards techniques enabling a network device (e.g., a target AP for a roaming procedure) to identify a sequence of AIDs across future epochs (e.g., time periods) and transmit the sequence of AIDs, alongside a privacy group placement and associated privacy parameter values, to a requesting STA. Such techniques enable a STA to benefit from the enhanced privacy and security offered by BPE and CPE while being able to seamlessly roam from one AP to another.

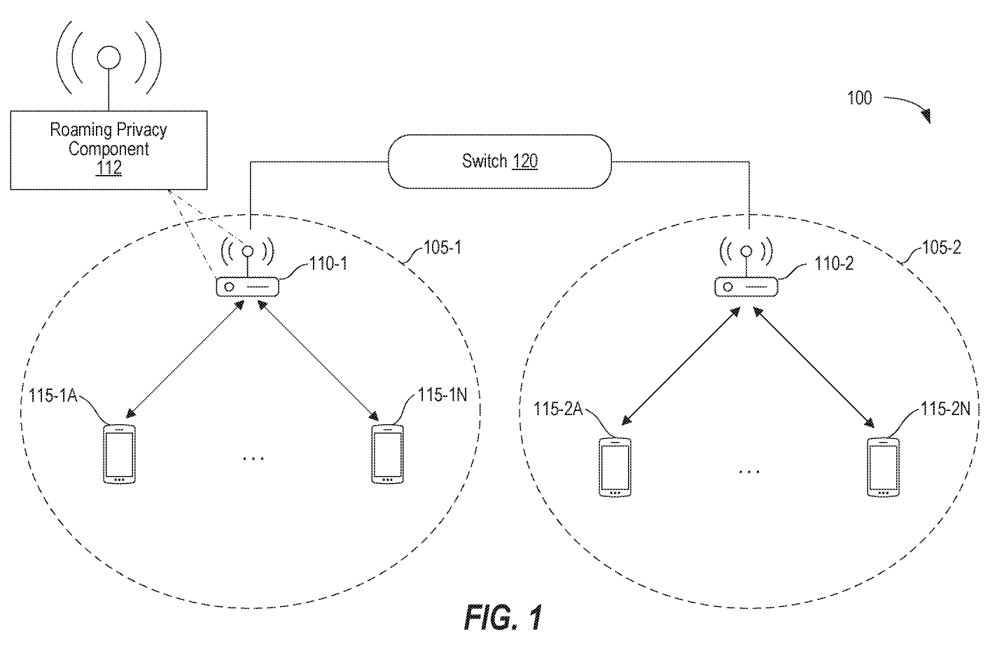

FIG. 1 depicts an example wireless environment 100 in which embodiments of the present disclosure may be implemented. As depicted, the environment 100 includes multiple Basic Service Sets 105-1 and 105-2 (collectively, “BSSs 105”), connected by a switch 120 to form an Extended Service Set. Although the Extended Service Set of the example wireless environment 100 is depicted as including only two BSSs, any number of BSSs may be included in other implementations.

Each of the BSSs 105 may include an AP, such as an AP 110-1 and an AP 110-2 (collectively, “APs 110”). Each AP 110 may generally correspond to an access point used to facilitate or provide connectivity in a wireless network (e.g., a wireless local area network (WLAN), e.g., using Wi-Fi protocols) and implement a BSS. Each respective AP 110 may be identified throughout the ESS with a respective unique BSSID, which wireless STAs may use to connect to and send data throughout a corresponding BSS. In the example wireless environment 100, both the AP 110-1 and an AP 110-2 may be a part of the same seamless mobility domain, such that STAs connected to either of the AP 110-1 or the AP 110-2 (discussed below) may seamlessly roam to the other AP (e.g., from the AP 110-1 to the AP 110-2, from the AP 110-2 to the AP 110-1, etc.).

Each of the APs 110 may be configured to provide wireless access to one or more wireless STAs (e.g., client devices), such as a collection of STAs 115-1A through STAs 115-1N or a collection of STAs 115-2A through STAs 115-2N (collectively, “STAs 115”). Each of STAs 115 may generally be representative of any computing device capable of wireless communications using the WLAN, such as a smartphone, tablet, laptop, wearable computing device (e.g., smartwatch), and the like.

Each of the APs 110 may be associated with any number of the associated set of STAs 115 for active wireless data communications. For example, as depicted, the STA 115-1A is associated with the AP 110-1. In some embodiments, each of the APs 110 can be concurrently connected to any number of client devices. In some embodiments, each AP 110 can operate as a single-link AP or as a multi-link device (MLD) AP, and each STA 115 can operate as a single-link station (STA) or as an MLD STA.

In some embodiments, any (or all) of the APs 110 are an EPP-capable AP, such that the AP is capable of implementing privacy enhancement techniques. For example, the AP 110-1 may be a privacy preserving AP (e.g., an EPP-capable AP) that implements EPP techniques, such as anonymizing (e.g., changing) AIDs for an associated STA (e.g., any of the STAs 115-1). That is, the AP 110-1 may determine an AID for the STA 115-1A during a first epoch (e.g., time period). The AP 110-1 may then determine a second AID for the STA 115-1A during a subsequent epoch, such that the AP and the STA 115-1A starts using the second AID starting from an epoch boundary representing the end of the first epoch and the start of the subsequent epoch. In some examples, different AIDs are transmitted to a STA in different responses (e.g., frames), while in some examples, a single response includes a set or sequence of AIDs representing an ordering of AIDs to be used, where a new AID from the sequence of AIDs starts being used by an AP and STAs at an epoch boundary.

In some examples, an EPP-capable AP manages one or more privacy groups (e.g., epoch groups), such that devices of the same privacy group may operate according to the same set of privacy parameters. For example, a privacy group may be associated with an epoch time, such that each STA in the privacy group change AIDs according to the epoch time of the privacy group. Accordingly, an epoch boundary may represent the time at which items of a specific privacy group switch (e.g., based on the epoch time indicating that an epoch ends).

In some examples, any EPP-capable AP of the APs 110 advertise the respective AP’s ability to support EPP techniques (e.g., privacy groups) using an Extended Robust Security Network (RSN) Element (RSNXE). For example, where the AP 110-1 is an EPP-capable AP, the AP 110-1 may set a Group EPP Epoch Supported field, in an Extended RSN Capabilities field of the RSNXE element, to a value of 1 to indicate that the AP 110-1 supports privacy groups. The AP 110-1 may transmit the RSNXE element to a STA of the STAs 115 as part of a probe response or a neighbor response (e.g., a Neighbor Report Response, a BSS Transition Management (BTM) response, and the like). In some examples, the RSNXE element is included in an enhanced Neighbor Report element.

In some examples, a STA connected to one of the APs 110 may wish to roam to another of the APs 110. As discussed above, the APs 110 may be part of the same SMD, such that a STA connected to any of the APs 110 may seamlessly roam to another of the APs 110. That is, a STA may transmit a Seamless Roaming request (e.g., as an Ultra High Reliability (UHR) Link Reconfiguration Request) to an AP of the APs 110 to initiate SMD roaming procedures. According to the techniques described herein, the APs 110 may include a roaming privacy component 112 configured to manage roaming requests from any of the APs 110 to an EPP-capable AP of the APs 110. In some examples, the AP responsible for receiving the roaming preparation request frame is the AP currently associated with the requesting STA. For example, the STA 115-1A may transmit the roaming preparation request to the AP 110-1. The roaming preparation may be followed by a roaming execution phase, where the STA performs roaming transition and roams to the target AP (discussed below). A roaming execution request may be sent to perform roaming execution, which may also be sent to the current serving AP (e.g., the AP currently associated with the requesting STA). In other examples, the roaming execution request can be sent directly to the target AP. For example, the STA 115-1A may transmit the roaming execution request directly to the AP 110-2.

In response to receiving a roaming preparation request (or, in some examples, a roaming execution request) from a wireless STA, the roaming privacy component 112 may determine a privacy group placement for a requesting STA. In some examples, the roaming privacy component 112 determines a privacy group placement for a requesting STA based on one or more privacy parameters included in the roaming preparation request or the roaming execution request (e.g., in an EPP element). In some examples, the roaming privacy component 112 determines a privacy group placement for a requesting STA based on a field or indicator included in the roaming preparation request or the roaming execution request, such as a flag indicating that the request is to join an EPP group. In some examples, the roaming privacy component 112 determines or selects a set of privacy parameters associated with the privacy group placement.

Additionally, the roaming privacy component 112 of the target AP may be configured to determine a sequence of AIDs for the requesting STA, based on the privacy group placement. For example, the roaming privacy component 112 may determine a sequence of AIDs that is associated with the privacy group for which the STA is to be placed in, such that the sequence of AIDs represents the set of AIDs to use for each epoch in the set of epochs (or epoch boundaries) indicated by the privacy group.

An AP of the APs 110 may transmit a roaming preparation response or a roaming execution response (e.g., a UHR Link Reconfiguration Response) to the requesting STA including the privacy group placement and the sequence of AIDs. In some examples, the response further includes privacy parameters determined or selected by the roaming privacy component 112 of the target AP. In some examples, the AP responsible for transmitting the response is the AP that received the request.

In various embodiments, each of the operations of the roaming privacy component 112 may take place during the SMD roaming preparation or roaming execution phases, although preference to one phase may be described below. In some examples, one operation of the roaming privacy component 112 takes place in one phase (e.g., the roaming preparation phase), while another operation takes place in a separate phase (e.g., the execution phase). For example, a group placement may be determined in the roaming preparation phase, while the sequence of AIDs may be determined in the roaming execution phase. In some examples, the operations of the roaming privacy component 112 occur in the same phase. For example, each of the group placement, the sequence of AIDs, and a set of privacy parameters, may be determined in the roaming preparation phase.

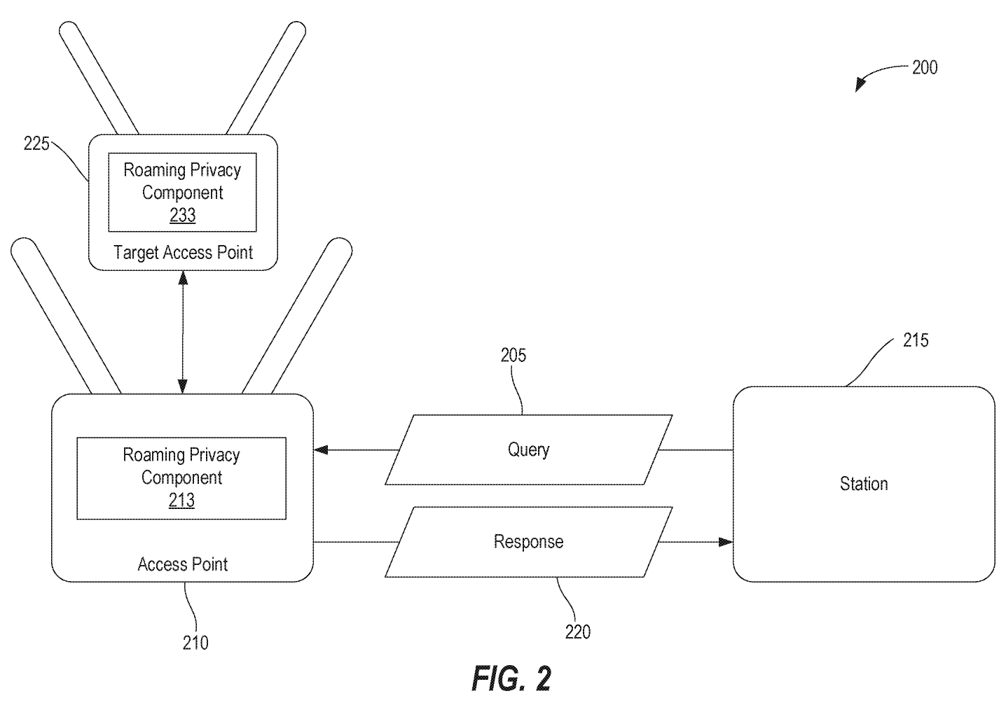

FIG. 2 depicts an example environment 200 for negotiating and assigning privacy parameter values in a wireless network, according to some embodiments of the present disclosure. In the illustrated example, an AP 210 (which may correspond to one of the APs 110 of FIG. 1) is communicatively coupled with a STA 215 (which may correspond to one of the STAs 115 of FIG. 1), such as via a WLAN (e.g., a Wi-Fi network). That is, in some examples, the AP 210 and the STA 215 correspond to any of the APs 110 of FIG. 1 and an associated STA of the STAs 115, respectively, such that the AP 210 may be referred to as a current AP. The target AP 225 may correspond to a target AP for the SMD roaming procedure, such that the STA 215 intends to roam to and is not currently associated with and may correspond to any of the APs 110 of FIG. 1 not associated with the STA 215. For example, where the AP 210 corresponds to the AP 110-1 of FIG. 1, and where the STA 215 corresponds to the STA 115-1A of FIG. 1, the target AP 225 may correspond to the AP 110-2. Both the AP 210 and the target AP 225 include a roaming privacy component 213 and 233. Although numbered differently for clarity, both the roaming privacy component 213 and the roaming privacy component 233 may correspond to, or operate in a similar manner to, the roaming privacy component 112 of FIG. 1.

In the environment 200, the STA 215 transmits a query 205 to the AP 210. For example, the STA 215 may transmit the query 205 via a management frame. The query 205 may generally correspond to, or include, a request for the STA 215 to roam to a target AP. For example, the query 205 may be, or may include, a roaming preparation request (e.g., a UHR Link Reconfiguration Request). In response to receiving the query 205, the AP 210, in conjunction with a roaming privacy component 213, may communicate with the target AP 225 to prepare the target AP 225 and determine privacy information needed to perform roaming execution for the STA 215 from the current AP of the STA 215 to the target AP. Although depicted as only a single query, in some examples, the query 205 can represent a set of queries or requests transmitted form the STA 215 to the AP 210. For example, the query 205 may include a roaming preparation request and a separate roaming execution request.

The roaming privacy component 213 at the current AP 210 may transfer relevant contextual information from the received query 205 to the roaming privacy component 233 of the target AP 225 (e.g., over a backhaul) to negotiate EPP parameters between the target AP and the STA 215. In response to receiving the contextual information, the roaming privacy component 233 of the target AP 225 may determine a set of EPP parameters to set up at the target AP 225 for the STA 215. To negotiate the EPP parameters, the roaming privacy component 213 of the AP 210 may identify an EPP element included in the query 205, which includes a set of desired parameters on behalf of the STA 215 and transfer that to the roaming privacy component 233 of the target AP 225 as part of the roaming context transfer. The desired parameters included in the EPP element may represent desired parameters for a privacy group (e.g., an epoch group or EPP group), such that the desired parameters are parameters for a desired privacy group that the STA 215 wishes to join. The roaming privacy component 233 of the target AP 225 may determine or select a set of EPP parameters, based on the desired parameters, for which the STA 215 will operate according to. For example, the selected EPP parameters may represent parameters associated with a privacy group placement for the STA 215, discussed below.

The roaming privacy component 233 may determine a privacy group placement for the STA 215, based on any desired parameters identified in the query 205. For example, the roaming privacy component 233 may map the desired parameters included in the query 205 to one of a plurality of privacy groups managed and supported by the target AP. In some examples, the roaming privacy component 233 determines that the query 205 (and any contextual information received from the AP 210) does not include any requested or desired EPP parameters, such that the STA 215 does not prefer a specific privacy group or set of privacy parameters. In such examples, the roaming privacy component 213 determines a privacy group placement for the STA 215 based on other factors, such as previous group assignments, number of STAs assigned to each of the current groups managed by the AP, rotation speed, epoch duration, traffic volume associated with each of the current groups managed by the AP. For example, the roaming privacy component 233 may determine if the AP 210 to which the STA 215 is currently associated with supports EPP features, and, if so, may base the privacy group placement based on a privacy group (and associated EPP parameters) for which the STA 215 is currently a part of (e.g., on the current AP 210). As another example, the roaming privacy component 233 selects a group based on the number of STAs and the traffic volume associated with groups, as discussed above, such that preference is given to groups with higher levels of traffic and/or higher numbers of STAs, enabling the STA 215 to more effectively anonymize itself in a larger pool of STAs. As another example, the roaming privacy component 213 may assign the STA 215 to a default group of the AP. After the roaming privacy component 233 on the target AP 225 determines the privacy group placement for the STA 215, the roaming privacy component 233 may provide the privacy group placement for the STA 215 to the current AP 210 (e.g. over the backhaul), which is then returned by the current AP 210 to the STA in the response 220 (discussed below).

In some examples, the EPP parameters is provided to the AP 210 (e.g., in the query 205, such as in an EPP element) as part of a roaming preparation request for seamless roaming, such that the STA 215 may be prepared for roaming to the target AP with the information on a privacy group placement and associated EPP parameters. In such examples, the target AP 225 assigns a privacy group placement for the STA as part of roaming preparation and provides that information to the current AP 210. In such examples, the response 220 represents, or includes, a roaming preparation response including the privacy group placement information, and associated EPP parameters (e.g., in an EPP element) for the STA 215. In other examples, the EPP parameters are provided to the AP 210 (e.g., in the query 205) as part of a roaming execution request. In such examples, the EPP parameters are transferred to the target AP 225 as part of a roaming context transfer procedure during the roaming execution phase. Accordingly, the roaming privacy component 233 of the target AP 225 may assign privacy group placements and EPP parameters for the STA 215 as part of the roaming execution phase and transfer the information back (e.g., in an EPP element) to the current AP 210, which may transmit the information to the STA 215 in the response 220 as, or as part of, a roaming execution response.

In some examples, the STA performs a roaming execution directly with the target AP 225 after performing roaming preparation via the current AP 210 (e.g., when the RSSI falls below certain threshold). In such examples, the EPP parameters may be provided directly to the target AP 225 as part of a query (not depicted) carried in the roaming execution request. Accordingly, the roaming privacy component 233 on the target AP 225 may determine a privacy group placement and EPP parameters for the STA 215, based on any desired parameters identified in the query received directly from the STA, as part of roaming execution phase and returns the privacy group placement and EPP parameters directly to the STA 215 as part of a response (not depicted) as part of a roaming execution response sent directly to the STA 215. In some examples, the query (including the desired privacy group placement and EPP parameters from the STA) can be included in a roaming request sent directly to the target AP 225 even without preparing the target AP 225 in advance. In such examples, the response (providing the privacy group placement and EPP parameters for the STA 215 at the target AP 225) may be included a roaming response sent directly by the target AP 225.

The roaming privacy component 233 at the target AP 225 may further determine a sequence of AIDs, which may be used by the target AP to identify and communicate with the STA 215 after the STA 215 roams to the target AP 225. That is, the roaming privacy component 233 determines a sequence of AIDs that will be assigned to the STA 215 for use at epoch boundaries (and thereafter for the epoch duration) for the STA 215, the epoch boundaries determined by the privacy group placement for the STA 215 determined by the roaming privacy component 233, as discussed above. In some examples, the sequence of AIDs is determined in the preparation phase of the seamless roaming request, such that the sequence of AIDs is provided to the STA 215 as part of the roaming preparation response, while in other examples, the sequence of AIDs is determined in the execution phase of the seamless roaming request, such that the sequence of AIDs is provided to the STA 215 as part of the roaming execution response.

The AP 210 may transmit one or more wireless frame to the STA 215 as, or as part of, the response 220. That is, as discussed above, the response 220 may be a single response transmitted to the STA 215, or may include multiple responses transmitted (e.g., separately) to the STA 215. For example, the response 220 may include a roaming preparation response, a roaming execution response, or both the preparation and execution responses. Accordingly, the AP 210 may encode one or more wireless frames that represent either the preparation response or execution response, such as a UHR Link Reconfiguration Response frame. As discussed above, UHR Link Reconfiguration Response frame may include information determined at a specific phase of the seamless roaming procedure, such as a privacy group placement (e.g., and associated EPP parameters) or a sequence of AIDs for the STA 215. Therefore, in some examples, such as when the privacy group placement and sequence of AIDs are both determined in the same phase of the seamless roaming procedure, the response 220 can represent a single UHR Link Reconfiguration Response frame including both the privacy group placement, sequence of AIDs, and any associated EPP parameters. In other examples, such as when the privacy group placement and sequence of AIDs are determined in separate phases of the seamless roaming procedure, the response 220 represents multiple UHR Link Reconfiguration Response frames, such as a first UHR Link Reconfiguration Response frame representing a preparation phase (e.g., including the privacy group placement), and a second UHR Link Reconfiguration Response frame representing an execution phase (e.g., including the sequence of AIDs).

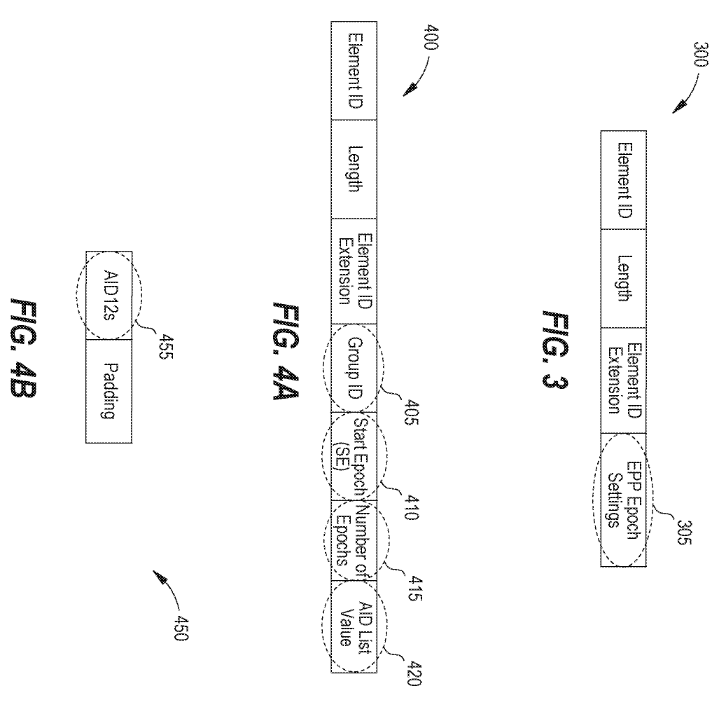

FIG. 3 depicts an example format 300 for signaling Enhanced Privacy Protection (EPP) parameters, according to some embodiments of the present disclosure.

As depicted, the example format 300 illustrates signaling of an EPP element. In the example format 300, EPP epoch settings (e.g., EPP parameters related to an EPP group or privacy group for which a STA is assigned to) may be included in an EPP Epoch Settings field 305 of the EPP element.

In the example format 300, any of the fields referenced or depicted may be one or more bits in length. Additionally, any of the fields referenced may be variable in length, such that a field may have a different length in one transmission than in a separate transmission. For example, the EPP Epoch Settings field 305 may be variable size, such that in one example, the field may hold only one parameter and associated value, while in another example, the field may include multiple parameters and associated values.

Additionally, different types of information may be indicated using different encoding mechanisms. That is, a plurality of encodings, including reserved or extensible values, may be used to represent any of the fields of the example format 300. Such signaling may be included in one or more management frames, such as a UHR Link Reconfiguration Request frame or UHR Link Reconfiguration Response frame.

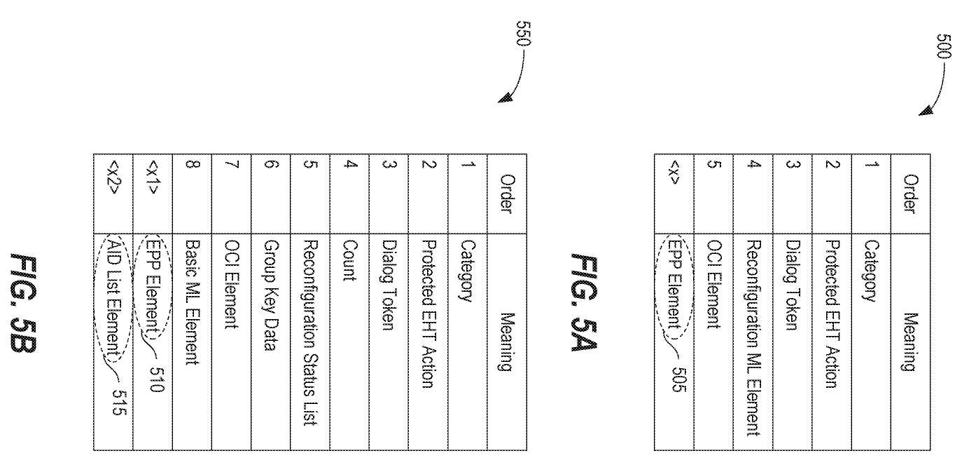

FIG. 4A depicts an example format 400 for signaling a sequence of association identifiers (AIDs), according to some embodiments of the present disclosure.

As depicted, the example format 400 illustrates signaling of AIDs in an AID List element. In the example format 400, an EPP group identifier (e.g., an identifier for a privacy or EPP epoch group to which a STA is assigned to) may be included in the EPP Group ID field 405 of the AID List element. A starting epoch value (e.g., a value indicating the future EPP epoch number where the first AID in the AID List value (discussed below) is assigned to be used for the STA) may be included in the Start Epoch field 410 of the AID List element. A value indicating the number of consecutive epochs for which the sequence of AIDs, below, are provided may be included in the Number of Epochs Field 415. A sequence of AIDs (e.g., a sequence of AIDs to be utilized by an AP and associated STA over a number of epochs) may be included in the AID List Value field 420 of the AID List element. The AID List Value field 420 is discussed in greater detail below, with respect to FIG. 4B.

In the example format 400, any of the fields referenced or depicted may be one or more bits in length. Additionally, any of the fields referenced may be variable in length, such that a field may have a different length in one transmission than in a separate transmission. For example, the AID List Value field 420 may be variable size, such that in one example, the field may hold a sequence of ten AIDs, representing AIDs to use over the next ten epochs, while in another example, the field may include fifty AIDs, representing AIDs to use over the next fifty epochs.

Additionally, different types of information by be indicated using different encoding mechanisms. That is, a plurality of encodings, including reserved or extensible values, may be used to represent any of the fields of the example format 400. Such signaling may be included in one or more management frames, such as a UHR Link Reconfiguration Request frame or UHR Link Reconfiguration Response frame.

FIG. 4B depicts an example field 450 for signaling each AID of a sequence of AIDs, according to some embodiments of the present disclosure.

As depicted, the example field 450 illustrates signaling of a sequence of AIDs in an AID List Value field. In the example field 450, an AID12 field 455, or set of AID12 fields 455, may be included. That is, the number of AID12 fields 455 included in the example field 450 may correspond to the number of epochs indicated in the Number of Epochs field 415 of the frame for which the example field 450 is included. For example, where the Number of Epochs field 415 in a frame indicates a value of fifty epochs, the example field 450 includes a set of fifty AID12 fields 455. Each AID12 field 455 may be 12 bits in length. Each AID12 field 455 may indicate the 12 LSBs of an AID assigned for a specific epoch, such that each AID12 field 455 corresponds to an epoch and may be ordered such that each consecutive AID12 field 455 corresponds to the next epoch. For example, a tenth AID12 field 455 may correspond to a tenth epoch.

Additionally, different types of information may be indicated using different encoding mechanisms. That is, a plurality of encodings, including reserved or extensible values, may be used to represent any of the fields of the example 450. Such signaling may be included in one or more elements, such as an AID List element. In some examples, the padding field of the example field 450 is used to align the field to any octet limits.

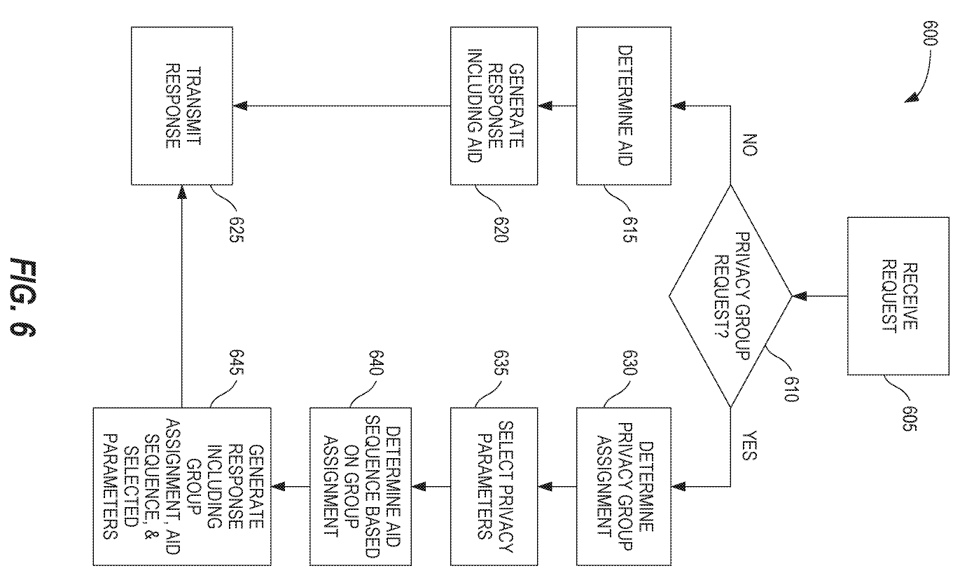

FIG. 5A depicts an example frame 500 for signaling privacy information in a roaming request, according to some embodiments of the present disclosure.

As depicted, the example frame 500 illustrates signaling information for a seamless roaming request, in a UHR Link Reconfiguration Request frame. The seamless roaming request may be a roaming preparation request (e.g., a ST preparation request) or a roaming execution request (e.g., a ST execution request). In the example frame 500, an EPP element, indicating requested EPP parameter and privacy group parameters, may be included in the EPP Element field 505. In some examples, the EPP element of the EPP Element field 505 is formatted according to the example format 300 of FIG. 3. Although depicted as being included at the end of the example frame 500, in some examples, the EPP Element field 505 can be included in a different position or placement within the frame.

FIG. 5B depicts an example frame 550 for signaling privacy information in a roaming response, according to some embodiments of the present disclosure.

As depicted, the example frame 550 illustrates signaling information for a seamless roaming response, in a UHR Link Reconfiguration Response frame. The seamless roaming response may be a roaming preparation response (e.g., a ST preparation response) or a roaming execution response (e.g., a ST execution response). In the example frame 550, an EPP element, indicating EPP parameter and privacy group placement information, may be included in the EPP Element field 510. In some examples, the EPP element of the EPP Element field 510 is formatted according to the example format 300 of FIG. 3. An AID List element, indicating a sequence of AIDs for a number of epochs, may be included in the AID List Element field 515. In some examples, the AID List element of the AID List Element field 515 is formatted according to the example format 400 of FIG. 4A. Although depicted as being included at the end of the example frame 500, in some examples, either of the EPP Element field 510 or the AID List Element field 515 can be included in a different position or placement within the frame.

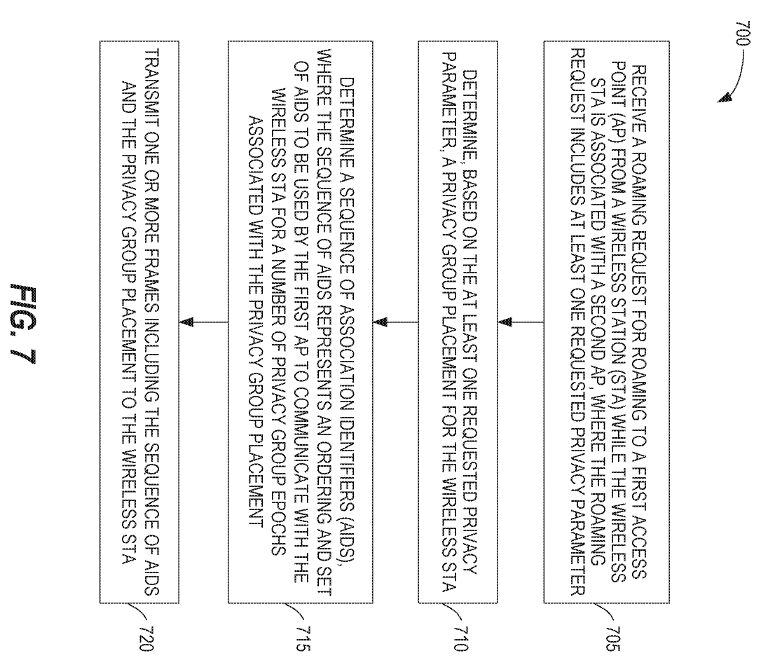

FIG. 6 is a flow diagram depicting an example method for assigning privacy parameter values to a wireless station in a wireless network, according to some embodiments of the present disclosure. The example method 600 may be performed by an AP, such as one of the APs 110 of FIG. 1 or the target AP 225 as depicted in FIG. 2.

At block 605, an AP (e.g., one of the APs 110 of FIG. 1 or the AP 210 as depicted in FIG. 2) receives a request from a wireless STA (e.g., one of the STAs 115 of FIG. 1 or the STA 215 of FIG. 2). More specifically, the AP may receive a seamless roaming request from the wireless STA, indicating that the STA wishes to roam from the AP the STA is currently associated with to a new AP (e.g., a target AP, such as the target AP 225 of FIG. 2). In some examples, the target AP receives the request directly from the wireless STA, while in other examples, a second AP (e.g., the AP the STA is currently associated with) receives the request and forwards (e.g., transmits) the request to the target AP (e.g., over a backhaul).

At block 610, the target AP determines whether the request includes or otherwise indicates a request to join a privacy group (e.g., an EPP group, an epoch group, etc.). For example, where the request includes, or is, a UHR Link Reconfiguration Request, the target AP may analyze the request for an EPP Element (e.g., in the EPP Element field 505 of the example frame 500 of FIG. 5) including requested EPP parameters or group values (e.g., in the EPP Epoch Settings field 305 of the example format 300 of FIG. 3). As another example, where the request includes, or is, a UHR Link Reconfiguration Request, the target AP may analyze the request for a per-STA Profile element, which may include an RSNXE element. For example, the target AP may analyze the RSNXE element for an Extended RSN Capabilities field, which in turn may include a Group EPP Epoch Supported field, the value of which may be used to indicate if the STA supports EPP grouping techniques (e.g., a value of 1) or not (e.g., a value of 0).

As another example, the target AP may analyze the request for a field explicitly indicating that the request is for the STA to join a privacy group. For example, the target AP may determine whether the request includes a “Join EPP Group Flag,” where a value of the flag indicates that the STA wishes to join an EPP group (e.g., a value of 1), and another value indicates that the STA does not wish to join an EPP group (e.g., a value of 0).

If the target AP determines that the request is not to join a privacy group, the target AP proceeds according to the “NO” branch to block 615. At block 615, the target AP determines a single AID for the requesting STA. At block 620, the target AP generates a response including the AID, such as a response included in, or representing, a seamless roaming response. Block 625 is discussed below.

If the target AP determines that the request is to join a privacy group, the target AP proceeds according to the “YES” branch to block 630. At block 630, based on the request, the target AP (or a component therein, such as the roaming privacy component 112 of any of the APs 110 of FIG. 1 and/or the roaming privacy component 233 of the target AP 225 of FIG. 2) sets up the target AP and determines a privacy group assignment for the STA. Initially, the target AP may determine a set of EPP parameters to use to set up the target AP and determine the privacy group placement. For example, as discussed above, the target AP may parse the request to identify an EPP Element indicating a set of requested EPP parameters. In some examples, where the request does not include any requested EPP parameters, but the STA is currently associated with an EPP-capable AP, the target AP determines a set of EPP parameters established for the connection between STA and the AP to which the STA is currently associated with.

The target AP may use the set of EPP parameters to set up the association between the STA and the target AP. Additionally, the target AP may determine a privacy group assignment for the STA. That is, the target AP may use the set of EPP parameters to determine a mapping for the STA to a privacy group (e.g., a privacy group implementing the same or similar EPP parameters and values). In some examples, the target AP generates a new privacy group, based on the identified or selected EPP parameters, and assigns the STA to the new privacy group.

At block 635, the target AP selects privacy parameters. That is, the target AP may select a set of response privacy parameters to include in a response to the STA. In some examples, the target AP selects the set of privacy parameters based on the request. For example, the target AP may select one or more privacy parameters (e.g., EPP parameters) included in the request from the STA, utilized by the STA in a current association with another EPP AP, and the like. In some examples, the target AP selects the set of privacy parameters based on the privacy group assignment determined in the previous block. For example, the target AP may select one or more privacy parameters associated with the privacy group for which the STA was placed in or assigned to.

At block 640, the target AP determines an AID sequence (e.g., a sequence of multiple AIDs) based at least in part on the privacy group assignment. That is, the target AP may determine a number of AIDs, where the sequence of AIDs represents an ordering of AIDs to be used by the target AP and the STA to communicate across various epochs (e.g., time periods). For example, at a first epoch, the first AID of the sequence of AIDs may be utilized. At an epoch boundary (e.g., the end of an epoch), the second AID of the sequence of AIDs may be utilized. The epoch boundary, or the length of an epoch, may be determined based on the privacy group assignment for the STA. For example, a privacy group may determine that all epochs are five minutes, such that the target AP and STA utilize a new AID from the sequence of AIDs every five minutes. In some examples, the target AP determines a number of AIDs for the sequence of AIDs for a certain number of epochs (e.g., the number of epochs to cover a certain time period). In some examples, the sequence of AIDs is included in an AID List element, such as in an AID List field formatted according to the example field 450 of FIG. 4B. In some examples, The AID List field is included in an AID List element formatted according to the example format 400 of FIG. 4A.

At block 645, the target AP generates a response including the privacy group assignment, the AID sequence, and any selected EPP parameters. More specifically, the target AP may generate a frame for use in a seamless roaming response, such as a UHR Link Reconfiguration Response frame (e.g., according to the example frame 550 of FIG. 5B).

At block 625, an AP transmits the response to the STA. In some examples, the response is transmitted as a preparation response (e.g., as part of a seamless roaming preparation phase). In some examples, the response is transmitted as an execution response (e.g., as part of a seamless roaming preparation phase). In some examples, the target AP transmits the response to the STA. In other examples, another AP (e.g., an AP that transmitted a query, or roaming request, from the STA to the target AP) receives the response from the target AP, and transmits the response to the STA. For example, the AP currently associated with the STA may receive the response from the target AP and transmit the response to the STA.

Although discussed with respect to block 645 and block 625 as a single response and transmission, in some examples, multiple responses can be transmitted (e.g., a preparation phase response and an execution phase response). In such examples, any of the privacy group assignment, the AID sequence, and any selected EPP parameters are included in any of the responses. For example, a first response (e.g., a preparation phase response) may include the privacy group placement, while a second response (e.g., an execution phase response, transmitted subsequent to the first response), may include the AID sequence and any selected EPP parameters.

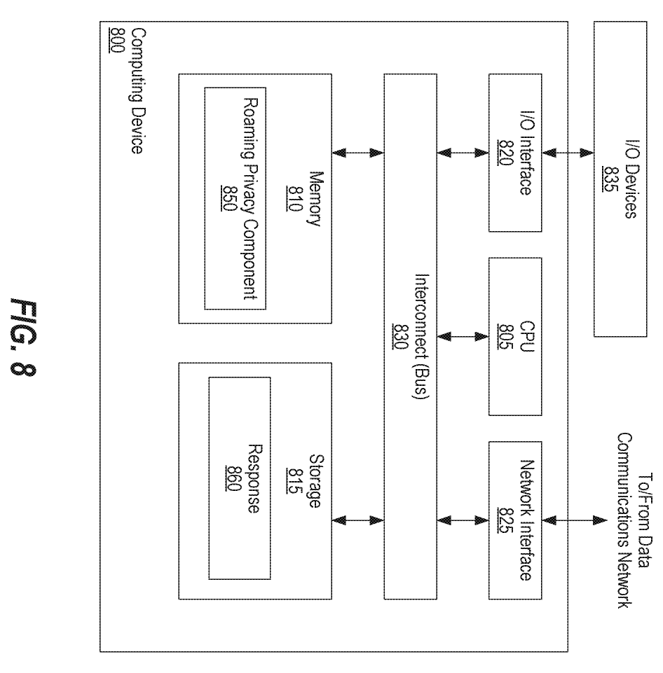

FIG. 7 is a flow diagram depicting an example method for determining and transmitting privacy parameter values, according to some embodiments of the present disclosure. The example method 700 may be performed by an AP, such as one of the APs 110 of FIG. 1 or the target AP 225 as depicted in FIG. 2.

At block 705, a roaming request is received for roaming to a first AP from a wireless STA while the wireless STA is associated with a second AP, where the roaming request includes at least one requested privacy parameter. In some examples, block 705 may correspond to, or provide additional or alternative details for, the operations discussed above with reference to block 605 of FIG. 6.

At block 710, a privacy group placement for the wireless STA is determined based on the at least one requested privacy parameter. In some examples, block 705 may correspond to, or provide additional or alternative details for, the operations discussed above with reference to block 630 of FIG. 6.

At block 715, a sequence of AIDs is determined, where the sequence of AIDs represents an ordering and set of AIDs to be used by the first AP to communicate with the wireless STA for a number of privacy group epochs associated with the privacy group placement. In some examples, block 705 may correspond to, or provide additional or alternative details for, the operations discussed above with reference to block 640 of FIG. 6.

At block 720, one or more frames including the sequence of AIDs and the privacy group placement are transmitted to the wireless STA. In some examples, block 705 may correspond to, or provide additional or alternative details for, the operations discussed above with reference to block 625 of FIG. 6.

In some embodiments, the operations of the example method 700 include selecting at least one response privacy parameter for the wireless STA based on the at least one requested privacy parameter. In some embodiments, the one or more frames further include the at least one response privacy parameter. In some examples, said operations may correspond to, or provide additional or alternative details for, the operations discussed above with reference to block 635 of FIG. 6. In some embodiments, the response privacy parameter is associated with a privacy group of the privacy group placement.

In some embodiments, the one or more frames include an EPP element. In some examples, the EPP Element may be formatted according to the example format 300 of FIG. 3.

In some embodiments the one or more frames are transmitted as part of a roaming preparation response for an SMD BSS transition procedure.

In some embodiments, the one or more frames are transmitted as part of a roaming execution response for an SMD BSS transition procedure.

In some examples, the one or more frames are (UHR Link Reconfiguration response frames.

In some embodiments, the roaming request includes a privacy group request. In some examples, the operations of the example method 700 include determining the privacy group placement is further based on the privacy group request. In some examples, the roaming request includes an EPP element. In some examples the roaming request is a UHR Link Reconfiguration request frame.

In some embodiments, the one or more frames are transmitted by the first AP.

In some embodiments, the one or more frames are transmitted by the second AP. In some examples, the operations of the example method 700 include receiving, by the second AP, the sequence of AIDs and the privacy group placement from the first AP.

In some embodiments, the sequence of AIDs and the privacy group placement are transmitted in a same frame of the one or more frames.

In some embodiments, the sequence of AIDs and the privacy group placement are transmitted in different frames of the one or more frames, where the sequence of AIDs is transmitted in one phase of roaming, and where the privacy group placement is transmitted in another phase of roaming.

FIG. 8 depicts an example computing device, such as a network device, configured to perform various embodiments of the present disclosure. Although depicted as a physical device, in embodiments, the computing device 800 may be implemented using any number of virtual or physical device(s) (e.g., in a cloud environment). In one embodiment, the computing device 800 corresponds to or implements an AP, such as any of the APs 110 or the target AP 225 of FIGS. 1 and 2, respectively, or the APs discussed above with reference to FIGS. 3-6.

As illustrated, the computing device 800 includes a CPU 805, a memory 810, a storage 815, a network interface 825, and one or more I/O interfaces 820. In the illustrated embodiment, the CPU 805 retrieves and executes programming instructions stored in the memory 810, as well as stores and retrieves application data residing in the memory 810, the storage 815, or both. The CPU 805 is generally representative of a single CPU, a single GPU, multiple CPUs, multiple GPUs, a single CPU having multiple processing cores, a single GPU having multiple processing cores, a microcontroller, an application-specific integrated circuit (ASIC), or a programmable logic device (PLD), and the like.

In some embodiments, the I/O devices 835 (such as keyboards, monitors, etc.) are connected via the I/O interface(s) 820. Further, via the network interface 825, the computing device 800 can be communicatively coupled with one or more other devices and components (e.g., via a network, which may include the Internet, local network(s), and the like). As illustrated, the CPU 805, the memory 810, the network interface(s) 825, and the I/O interface(s) 820 are communicatively coupled by one or more buses 830.

The storage 815 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 815 may store a variety of data for the efficient functioning of the system.

The memory 810 is generally included to be representative of a random-access memory. The memory 810 may store processor-executable software code containing instructions that, when executed by the CPU 805, enable the computing device 800 to perform various functions described herein for wireless communication. The memory 810 may include random access memory (RAM) and read-only memory (ROM).

As depicted, the memory 810 includes a roaming privacy component 850. Although depicted as a discrete component for conceptual clarity, in embodiments, the operations of the roaming privacy component 850 (and others not illustrated) may be combined or distributed across any number of components. Further, although depicted as software residing in the memory 810, in embodiments, the operations of the roaming privacy component 850 (and others not illustrated) may be implemented using hardware, software, or a combination of hardware and software.

The roaming privacy component 850 may generally correspond, and operate in a similar manner to, the roaming privacy component 112 of any of the APs 110 of FIG. 1 and/or the roaming privacy component 233 of the target AP 225 of FIG. 2. The roaming privacy component 850 may be configured to negotiate EPP parameters between a target AP and a requesting STA, in order to setup and prepare the target AP. The roaming privacy component 850 may be further configured to determine a privacy group placement for the requesting STA, based on any desired parameters identified in a request from the STA. The roaming privacy component 850 may be further configured to determine a sequence of AIDs, which may be utilized by the target AP to identify and communicate with the STA. The roaming privacy component 850 may generate one or more responses 860 including any of the EPP parameters, the privacy group placement, or the sequence of AIDs, and may transmit the response(s) 860 to the STA.

As discussed above, the computing device 800 may generate one or more responses, such as the response 860. The response(s) 860 may be transmitted to STAs (e.g., any of the STAs 115 or the STA 215 of FIGS. 1 and 2, respectively) to provide the STA with information on EPP parameters and AIDs to use upon roaming from a current AP to a target AP (e.g., as part of a seamless roaming operation). For example, the computing device 800 may transmit the response 860, such as a UHR Link Reconfiguration Response frame including an EPP Element and an AID List Element, to the STA, as described above. Although depicted as residing in the storage 815, the response 860 of the computing device 800 may be stored in any suitable location.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the "C" programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A method, comprising:
receiving a roaming request for roaming to a first access point (AP) from a wireless station (STA) while the wireless STA is associated with a second AP, wherein the roaming request includes at least one requested privacy parameter;
determining, by the first AP and based on the at least one requested privacy parameter, a privacy group placement for the wireless STA;
determining, by the first AP, a sequence of association identifiers (AIDs), wherein the sequence of AIDs represents an ordering and set of AIDs to be used by the first AP to communicate with the wireless STA for a number of privacy group epochs associated with the privacy group placement; and
transmitting one or more frames comprising the sequence of AIDs and the privacy group placement to the wireless STA.

2. The method of claim 1, wherein the method further comprises selecting, by the first AP and based on the at least one requested privacy parameter, at least one response privacy parameter for the wireless STA, and wherein the one or more frames further comprise the at least one response privacy parameter.

3. The method of claim 2, wherein the response privacy parameter is associated with a privacy group of the privacy group placement.

4. The method of claim 1, wherein the one or more frames include an Enhanced Privacy Protection (EPP) element.

5. The method of claim 1, wherein the one or more frames are transmitted as part of a roaming preparation response for a Seamless Mobility Domain (SMD) Basic Service Set (BSS) transition procedure.

6. The method of claim 1, wherein the one or more frames are transmitted as part of a roaming execution response for a Seamless Mobility Domain (SMD) Basic Service Set (BSS) transition procedure.

7. The method of claim 1, wherein the one or more frames are Ultra High Reliability (UHR) Link Reconfiguration response frames.

8. The method of claim 1, wherein the roaming request includes a privacy group request, and wherein determining the privacy group placement is further based on the privacy group request.

9. The method of claim 8, wherein the roaming request includes an Enhanced Privacy Protection (EPP) element.

10. The method of claim 8, wherein the roaming request is an Ultra High Reliability (UHR) Link Reconfiguration request frame.

11. The method of claim 1, wherein the one or more frames are transmitted by the first AP.

12. The method of claim 1, wherein the one or more frames are transmitted by the second AP, and wherein the method further comprises receiving, by the second AP, the sequence of AIDs and the privacy group placement from the first AP.

13. The method of claim 1, wherein the sequence of AIDs and the privacy group placement are transmitted in a same frame of the one or more frames.

14. The method of claim 1, wherein the sequence of AIDs and the privacy group placement are transmitted in different frames of the one or more frames, wherein the sequence of AIDs is transmitted in a one phase of roaming, and wherein the privacy group placement is transmitted in another phase of roaming.

15. An access point (AP) comprising:
one or more memories; and
one or more processors communicatively coupled to the one or more memories, wherein the one or more processors are configured to, individually or collectively, perform operations comprising:
receiving a roaming request for roaming to a first access point (AP) from a wireless station (STA) while the wireless STA is associated with a second AP, wherein the roaming request includes at least one requested privacy parameter;
determining, by the first AP and based on the at least one requested privacy parameter, a privacy group placement for the wireless STA;
determining, by the first AP, a sequence of association identifiers (AIDs), wherein the sequence of AIDs represents an ordering and set of AIDs to be used by the first AP to communicate with the wireless STA for a number of privacy group epochs associated with the privacy group placement; and
transmitting one or more frames comprising the sequence of AIDs and the privacy group placement to the wireless STA.

16. The access point of claim 15, wherein the operations further comprise selecting, by the first AP and based on the at least one requested privacy parameter, at least one response privacy parameter for the wireless STA, and wherein the one or more frames further comprise the at least one response privacy parameter.

17. The access point of claim 16, wherein the response privacy parameter is associated with a privacy group of the privacy group placement.

18. The access point of claim 15, wherein the one or more frames include an Enhanced Privacy Protection (EPP) element.

19. The access point of claim 15, wherein the roaming request includes a privacy group request, and wherein determining the privacy group placement is further based on the privacy group request.

20. A non-transitory computer readable storage medium comprising instructions that when executed configure one or more processors of an access point to perform operations comprising:
receiving a roaming request for roaming to a first access point (AP) from a wireless station (STA) while the wireless STA is associated with a second AP, wherein the roaming request includes at least one requested privacy parameter;
determining, by the first AP and based on the at least one requested privacy parameter, a privacy group placement for the wireless STA;
determining, by the first AP, a sequence of association identifiers (AIDs), wherein the sequence of AIDs represents an ordering and set of AIDs to be used by the first AP to communicate with the wireless STA for a number of privacy group epochs associated with the privacy group placement; and
transmitting one or more frames comprising the sequence of AIDs and the privacy group placement to the wireless STA.
